(19) United States
(12) Patent Application Publication
(10) Pub. No.: US 2016/0305617 A1
(43) Pub. Date: Oct. 20, 2016

(54) LED LIGHTING FIXTURE WITH HEAT SINK CASING

(71) Applicants: Lapwah LIN, Richmond (CA); Seklun CHAN, Richmond (CA)

(72) Inventors: Lapwah Lin, Richmond (CA); Seklun Chan, Richmond (CA)

(21) Appl. No.: 14/370,839

(22) PCT Filed: Jan. 8, 2014
(86) PCT No.: PCT/CN14/70337

§ 371 Date: Jul. 7, 2014

(30) Foreign Application Priority Data
Jan. 6, 2014 (CN) 201410005468.X
Jan. 6, 2014 (CN) 201420006843.8

(51) Int. Cl. F21K 99/00; F21V 19/00; F21V 17/10; F21S 8/04; F21V 29/70; F21V 3/00; F21V 23/00; F21V 23/02; F21V 17/12; F21V 29/85

(52) U.S. Cl. CPC F21K 9/175; F21V 17/12; F21V 19/003; F21V 17/105; F21V 29/85; F21V 29/70; F21V 3/00; F21V 23/006; F21V 23/02; F21S 8/04; F21Y 2101/02; F21Y 2103/003

(57) ABSTRACT

A heat sink casing comprising an elongated base having a seat portion for receiving at least one LED bar; and a back plate coupled to the base and provided with an interface to a base member of a traditional lighting panel is disclosed. The casing it self can act as heat sink for the LED bars mounted thereon and can therefore improve heat dissipation efficiency and reduce cost of each LED lighting fixture using the same. An LED lighting fixture using the above heat sink casing is also disclosed.

### BACKGROUND

1. Technical Field

The invention relates to illumination devices and particularly to LED based illumination devices.

2. Background Art

Illumination devices such as incandescent bulb and fluorescent light tube based illumination fixtures have been widely used in offices areas and in households. A fluorescent light tube based illumination fixtures normally comprises a lighting fixture having two adaptors fixed at predetermined distance, and a fluorescent light tube secured by the two adaptors and electrically connected with the two adaptors, the two adaptors are connected to the AC power through a ballast. Traditional Fluorescent light tube based illumination fixtures may also comprises a starter to provide the initial ionization voltage. Although fluorescent light tube based illumination fixtures such as lighting panels can provide evenly distributed light and have been widely fitted in offices areas and commercial venues in the form of light boxes and/or lighting arrays, the fact that the fluorescent light tube itself contains mercury make it a potential hazard to the environment and is therefore difficult to be safely disposed or can only be disposed at high cost.

Compact fluorescent lamp (CFL), is another form of fluorescent tube based illumination device which can provide equal illumination effect with less power consumption and is therefore also called energy saving lamp. A compact fluorescent lamp uses a tube which is curved or folded to fit into the space of an incandescent bulb, and a compact electronic ballast in the base of the lamp. Still due to the mercury in the tube, the lamp of this type is not environment friendly.

Recently, with maturation of LED technology, lifecycle of a LED component is increasing while the unit cost is dropping. Benefit from the cost reduction, attempts have been made to incorporate LED components into fixtures of traditional incandescent bulb shape to form LED bulbs or of traditional fluorescent light tube shape to form LED tubes. For LED components however, heat dissipation is always a key issue as only about 15% of the input power is converted into light whereas nearly 85% of the input power is converted into heat. Lift cycle of a LED component can be significantly reduced and the stability of the LED component can be degraded due to high LED junction temperature if heat generated by the LED component cannot be dissipated efficiently

A common means in the art to control heat dissipation of LED bulb or LED tube within an acceptable range is to limit the number of LED components contained in a LED bulb or LED tube, therefore, LED bulbs or LED tubes in the market normally have low output power due to limited number of LED components contained. As a result, it is difficult to achieve energy saving and low cost at the same time since more LED bulbs or LED tubes need to be used to realize the same illumination effect.

Typically, due to insufficient heat dissipation of the LEDs and the LED driver integrated within the tubular body, a low power output LED tube in the shape of a fluorescent tube can only has an output in the range of 15 W to 22 W. Therefore, in order to replace the fluorescent tubes in a traditional lighting panel with four fluorescent tubes, at least four LED tubes are required (20 W×4=80 W) are required to provide same lumen with relatively lower energy. However, four LED tubes can be costly which may be an obstacle for the replacement of fluorescent tubes with LED tubes.

Moreover, retrofitting of the LED tubes in the prior art to a traditional lighting panel can be time consuming and arduous because new LED driver has to be added and the wires has to be rerouted.

Therefore, there is a need in the art for an improved LED lighting fixture having an output power that can generate similar or even higher lumen compared with four fluorescent light tubes and can therefore replace four traditional fluorescent light tubes or four low power LED tubes.

### SUMMARY OF INVENTION

Various embodiment of the invention direct to solutions to the above problems.

According to one aspect of the invention, a heat sink casing is proposes. The heat sink casing can comprises a base made from thermo conductive materials which can comprises a seat portion for coupling at least one LED bar; and a back plate made also from thermo conductive materials, which coupled to the base and is provided with an interface for retrofitting to a traditional lighting fixture.

In some embodiment of the invention, the interface can comprise a magnetic interface. In more preferred embodiment, the interface can alternatively or additionally comprise at least one mounting hole though which the back plate is fastened to the base of the traditional lighting panel or to a ceiling.

In some embodiments, the seat portion can be configured to be receivable of a plurality of LED bars arranged in a herringbone, a triangle, a rectangular column, a polygonal column, a semi-sphere, a cylinder, or a half-cylinder.

In some embodiments, the seat portion can comprise at least one slot for receiving the at least one LED bar. In more preferred embodiments, the seat portion can comprise two slots for receiving two LED bars, wherein the two slots incline from their sides adjoined to one another to their sides distance to one another.

In preferred embodiments, the base can further comprise a web portion, a first sidewall elevated from the web portion and pivotably coupled to a side of the back plate; and a second sidewall elevated from the web portion and securable to an opposite side of the back plate.

Another aspect of the present disclosure may involve an improved LED lighting fixture. In some embodiments, the LED lighting fixture can comprise a heat sink casing which comprises an elongated base having a seat portion for receiving at least one LED bar; and a back plate coupled to the base and provided with an interface to a base of a traditional lighting panel; wherein both the base and the back plate are made from a thermal conductive material; at least one LED bar received in the seat portion; at least one LED driver, coupled to the LED bar; and a diffusion cover coupled to the heat sink casing for diffusing the light emitted by the LED bar.

Similarly, the interface can comprise a magnetic interface. More preferably, the interface can comprise at least one mounting hole though which the back plate can be fastened to the base member of the traditional lighting panel or to a ceiling.

In some embodiments, the seat portion can be configured to be receivable of a plurality of LED bars arranged in a herringbone, a triangle, a rectangular column, a polygonal column, a semi-sphere, a cylinder, or a half-cylinder.

In some embodiments, the seat portion can comprise at least one slot for receiving the at least one LED bar. In more preferred embodiments, the seat portion can comprise two slots for receiving two LED bars, wherein the two slots incline from their sides adjoined to one another to their sides distance to one another.

In some embodiments, the base can further comprise a web portion, a first sidewall elevated from the web portion and pivotably coupled to a side of the back plate; and a second sidewall elevated from the web portion and securable to an opposite side of the back plate.

In some embodiments, the LED lighting fixture can further comprise a front cover affixed to a front end of the base and a rear cover affixed to a rear end of the base so that a chamber can be formed.

In most preferred embodiments, the front cover and the rear cover are affixed on the base with screws which act as pins for pivotably coupling the back plate and the first sidewall.

In other embodiments, at least one of the front cover and the rear cover is provided with an opening for connecting wires of the LED driver to extend through.

In some embodiments, the LED lighting fixture can further comprise a fan assembly attached to an opening provided on at least one of the front cover and the rear cover, or on one of the first side wall and the second side wall.

In the above embodiments, the LED bar can comprise a printed circuit board, PCB, by which it is received in the slot of the seat portion; and a plurality of LED components mounted on the printed circuit board; wherein the printed circuit board is coated with high thermal conductive material.

The LEDs on the PCB can be any LED component ready on shelf and can also be newly emerged components, such AC LED or OLED.

The heat sink casing of design turns the casing into an immense heat sink such that heat generated by the LEDs on the LED bar as well as by the LED driver can be quickly and effectively dissipated so that the LEDs as well as the LED driver can work at an ideal temperature which can consequently extend their service life.

Moreover, as the LED lighting fixture no longer contains separate heat sink, the overall size is reduced which can facilitate mounting of the fixture. Also, by employing the heat sink casing, the overall cost of the LED lighting fixture can be reduced.

The length of the heat sink casing can be increased as required and the length of the LED can be increased accordingly. A LED lighting fixture in the length of a standard fluorescent tube can have a minimum output power of 80 W. Thereby, a LED lighting fixture can replace eight traditional fluorescent tubes or eight low output power LED tubes.

In a relatively high temperature working environment, the LED lighting fixture with the fan assembly can be used to enhance heat dissipation efficiency.

In most cases, the LED lighting fixture can be mounted on the ceiling directly as an individual illumination device. In other cases however, the LED lighting fixtures according to some embodiments of the invention can be used to retrofit existing illumination devices, for example, a base member of an existing lighting panel that contains several fluorescent lighting fixtures. The retrofitting process is simple as only two wires of the LED driver need to be connected to the AC electric supply, no other connection is required.

These and other aspects of the present invention are described in the Detailed Description below and the accompanying figures. Other aspects and features of embodiments of the present invention will become apparent to those of ordinary skill in the art upon reviewing the following description of embodiments of the present invention in concert with the figures. While features of the present invention may be discussed relative to certain embodiments and figures, all embodiments of the present invention can include one or more of the features discussed herein. While one or more embodiments may be discussed as having certain advantageous features, one or more of such features may also be used with the various embodiments of the invention discussed herein. In similar fashion, while exemplary embodiments may be discussed below as system or method embodiments, it is to be understood that such exemplary embodiments can be implemented in various devices, systems, and methods of the present invention.

### DESCRIPTION OF DRAWINGS

FIG. 1A is a perspective view of an improved LED lighting fixture, in accordance with some embodiments of the present invention.

FIG. 1B is a cross sectional view of the LED lighting fixture in FIG. 1A, in accordance with some embodiments of the present invention.

FIG. 2A is an exploded view of an improved LED lighting fixture, in accordance with some embodiments of the present invention.

FIG. 2B is a sectional view of a base of the LED lighting fixture of FIG. 2A, in accordance with some embodiments of the present invention.

FIG. 2C is a sectional view of a back plate of the LED lighting fixture of FIG. 2A, in accordance with some embodiments of the present invention.

FIG. 3A is a side view of a front end cover of an improved LED lighting fixture, in accordance with some embodiments of the present invention.

FIG. 3B is a sectional view of the front end cover in FIG. 3A, in accordance with some embodiments of the present invention.

FIG. 3C is a side view of a rear end cover of an improved LED lighting fixture, in accordance with some embodiments of the present invention.

FIG. 3D is a sectional view of the rear end cover in FIG. 3C, in accordance with some embodiments of the present invention.

FIG. 4A is a sectional view of a base of the LED lighting fixture of FIG. 2A with LED bar as well as LED driver fitted in, in accordance with some embodiments of the present invention.

FIG. 4B is a sectional view of a back plate of the LED lighting fixture of FIG. 2A having a snap-in fit configuration, in accordance with some embodiments of the present invention.

FIG. 5A is a perspective view of an improved LED lighting fixture, in accordance with some embodiments of the present invention.

FIG. 5B is a perspective view of an improved LED lighting fixture from another angle, in accordance with some embodiments of the present invention.

FIG. 5C is a perspective, partially sectional view of an improved LED lighting fixture, in accordance with some embodiments of the present invention.

FIG. 5D is a top view of an improved LED lighting fixture, in accordance with some embodiments of the present invention.

FIG. 5E is a perspective, partially sectional view of an improved LED lighting fixture, in accordance with some embodiments of the present invention.

FIG. 6 is a perspective view showing fitting of the LED lighting fixture into existing florescent light fixture, in accordance with some embodiments of the present invention.

FIG. 7A is a schematic showing wiring layout of the traditional fluorescent lighting fixture according to embodiments of the present invention.

FIG. 7B is a schematic showing the connection of the AC electric supply and the LED lighting fixture according to embodiments of the present invention.

FIG. 7C is a schematic showing wiring layout of the fluorescent lighting fixture in prior art.

FIG. 7D is a schematic showing wiring layout of the low output LED tubes in prior art.

### DETAILED DESCRIPTION

To facilitate an understanding of the principles and features of the various embodiments of the invention, various illustrative embodiments are explained below.

Although exemplary embodiments of the invention are explained in detail as being LED lighting fixture in general, it is to be understood that other embodiments are contemplated. Accordingly, where the terms “LED light fixture,” “LED lighting fixture” and related terms are used throughout this disclosure, it will be understood that other entities, objects, or activities can take the place of these in various embodiments of the invention. It is not intended that the invention is limited in its scope to the details of construction and arrangement of components set forth in the following description or examples. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named. Furthermore, it is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

As explained above, a problem with traditional LED lighting fixtures are relatively low heat dissipation efficiency. Typically, heat accumulated within a casing of a LED lighting fixture due to low heat dissipation efficiency can expedite the aging procedure of the components contained therein, especially the LED components and the LED driver.

Unlike traditional designs, embodiments of the present invention provide several exemplary LED lighting fixtures that are capable of dissipating most of the heat generated by the LED components in an efficient way.

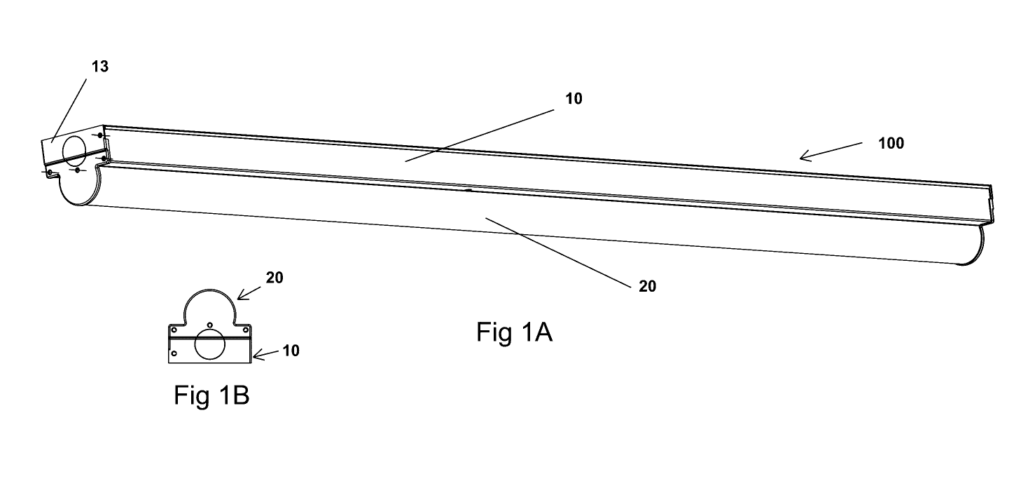

As shown in FIGS. 1A and 1B, the present invention can be a LED light fixture takes the shape of a traditional florescent light tube fixture. The LED light fixture 100 comprises a casing 10 and a light diffusing cover 20 coupled to the casing. It is important that the casing 10 is provided with a seat portion for receiving at least one LED array 30 and a chamber for receiving a circuitry necessary for driving the LED array. The seat can be provided for example on a surface of the casing where the light diffusing cover 20 is coupled.

Herein the circuitry necessary for driving the LED components on the LED array is collectively named as a LED driver.

Herein the LED array refers to a type of LED subassembly comprised of a plurality number of LED components or LEDs connected in series, in parallel or a combination of serial and parallel connection on a rigid or flexible substrate in which wires are prefabricated for connecting the LED components or LEDs and an interface is provided for connecting the LED driver introduced above. Examples of the rigid substrate can be a Printed Circuit Board (PCB) or a Printed Wire Board (PWB), example of a flexible substrate can be a Flexible Printed Circuit Board (FPCB). A LED array implemented on a rigid substrate is also called a LED bar, and a LED array implemented on a flexible substrate is also called a LED band. The LED array can be any length and width desired for a particular design. By extending the length and/or the width of the substrate, the total output power of the LED array can be increased.

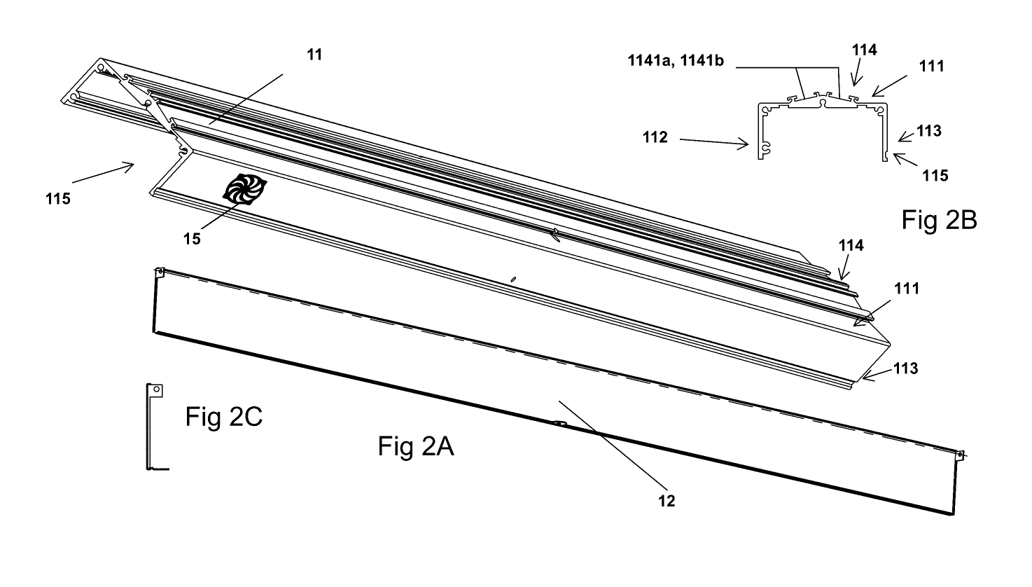

An exemplary embodiment of the present invention is illustrated in FIGS. 1A and 1B. Example of the casing 10 of one embodiment is illustrated in more detail in FIGS. 2A to 2C. As shown in the FIGS. 1A, 1B, 2A, 2B and 2C, the casing comprises a base 11, a back plate 12 pivotally coupled to the base 11, and two end covers, i.e. a front end cover 13 and a rear end cover 14, affixed to the subassembly formed by the base 11 and the back plate 12.

The base 11 is preferably in an elongated configuration which comprises a web portion 111 and two side walls 112 and 113, i.e. a first sidewall 112 and a second sidewall 113, extended and/or elevated from the web portion 111 so that a channel 115 is formed in the base 11. On an external surface of the web portion, i.e. the surface opposite from the elevation direction of the two side walls, a seat portion 114 is provided for receiving the above mentioned at least one LED array 30. In preferred embodiments, the web portion 111 and the two side walls 112, 113 are integrally formed, e.g. by mold casting. In other embodiments however, they can be separately formed and jointed together by, e.g. fastening or welding. In order to efficiently dissipate heat generated by the at least one LED array, it is important that the web portion 111,the side walls 112 and 113 and the seat portion 114 forming the base are all made from thermo conductive or high thermo conductive materials such as aluminum, copper, aluminum alloy, copper alloy among other things. Alternatively, the base 11 can be made from low thermo conductive materials and is coated with high thermo conductive materials. As a result, expanded heat dissipation areas are constituted by the web portion and the side walls.

In this embodiment, the back plate 12 substantially coextends with the web portion 111 of the base 11 such that it substantially covers the channel of the base 11. The back plate is made from a sheet material identical or similar to the material for the base 11. A member for pivotally coupling the base 11 is provided on a side of the back plate 12, the component can be a pin, a pin hole for a hinge or a seat for a shaft for coupling a complementary member provided on the base 11.

On one sidewall of the base 11, e.g. a first side wall 112, the complementary member is formed or affixed for mating the member on the back plate 12.

The back plate 12 can be further secured to the base 11 via a securing mechanism which can be a snap in fit configuration comprising, for example, a protruding rib 1222 provided along the entire length of a lip portion extended upright from the back plate 12, and a longitudinal slot 1131 for receiving the protruding rib formed on the second sidewall 113 of the base 11, or vise versa. Alternatively, the protrusion 1222 may be several individual protrusions receivable in the slot 1131. The securing mechanism can also be other snap-in fit configurations, notching configurations and fastening configurations for example and not intend to limit.

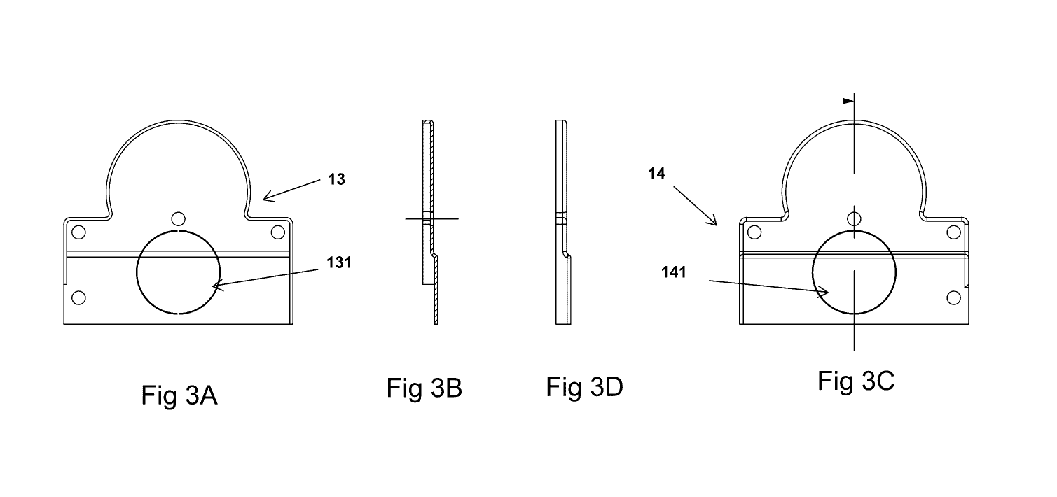

As shown in the above mentioned Figures, the subassembly formed by the base 11 and the back plate 12 still has two end openings along its longitudinal axis, which can be closed by a front end cover 13 and a rear end cover 14 respectively. Exemplary configurations of the front end cover 13 and the rear end cover 14 are illustrated in FIGS. 3A to 3D. As shown in these Figures, the front end cover 13 and the rear end cover can be in the shape consistent with the profile of the subassembly formed by the base 11 and the back plate 12 and are affixed thereto by fasteners, for example, screws. In preferred embodiments, at least one of the front end cover 13 and the rear end cover 14 is provided with an opening for the connection wires of a LED driver to extend out from the casing for connecting to AC electric supply. Alternatively, the covers 13 and 14 can be intact and the connection wires of a LED driver can extend out from an opening on one of the side wall 112 and 113 of the base 11 or formed into a socket fixed on the side wall of the base 11.

The base 11 in one preferred embodiment of the present invention is illustrated in FIG. 2A and 2B. The sidewalls 112 and 113 of the base in this embodiment extend and elevate substantially vertically from the web portion 111 so that the subassembly of the base 11 and the back plate 12 takes a substantially the geometry of a cuboid. The seat portion 114 can be formed as a part of the web portion 111 or can be formed separately and fastened to the web portion 111.

The seat portion 114 as illustrated in FIGS. 2A and 2B comprises surfaces 1141 for mounting LED arrays. In this embodiment, the surfaces 1141 are provided with two symmetrically arranged slots 1141a, 1141b extending along the entire length of the seat portion for accommodating the LED arrays with right substrates, e.g. PCB or PWB. Alternatively, the number of slots can be one, three, or four instead of two with slight adjustment of the contour of the seat portion 114. If only one slot is provided, it is preferable that the slot is positioned approximately in the center of the seat portion. If for example three slots are desired, it is preferable that the seat portion 114 is provided with three surfaces which are equally spaced from one another. In other embodiments, the surface 1141 can have an intact plane for affixing, e.g., by adhering or bonding LED arrays with flexible substrates, i.e. FPCB. Similarly, the number of surfaces for affixing LED arrays with flexible substrates can be one, two, or three among other things.

As illustrated in FIGS. 2A and 2B, it is preferable that the surfaces bearing the slots incline downwardly from the junction of the two surfaces to the sides distance from one another. In such arrangement, the illumination angle of the overall lighting device is expanded compared to the arrangement in which the two slots are arranged on the same plane.

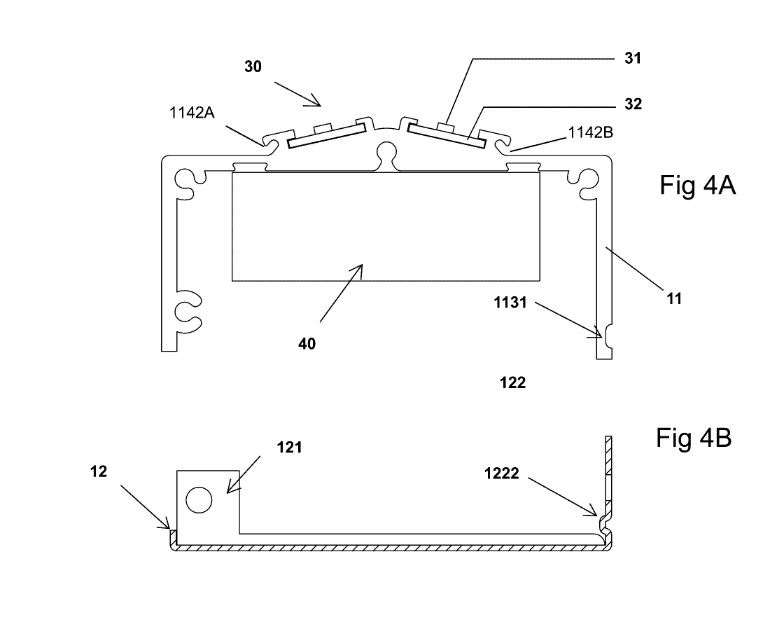

A sectional view of the base 11 and the back plate 12 separated from one another is illustrated in FIGS. 4A and 4B. As shown in the Figure, two LED arrays 30 are fitted in the slots on the seat portion and a LED driver 40 for illuminating the LEDs on the LED arrays is mounted in the chamber of the base 11 in a position proximate the back of the seat portion. Although shortest wiring path is achieved by affixing the LED driver 40 to the back of the seat portion 114, it should be understood that the LED driver 40 can also be affixed to other locations within the chamber of the base 11 to improve heat dissipation.

It is depicted in FIGS. 2A and 4 that a side of the back plate 12 as well as corresponding side wall of the base 11 is provided with pin bearings 121 for coupling a pin member. In addition to traditional pin members, bolt and screw for affixing the front end cover and the rear end cover to the subassembly of the and the back plate can also act as pin member for coupling complementary pin bearings on a side wall of the base 11.

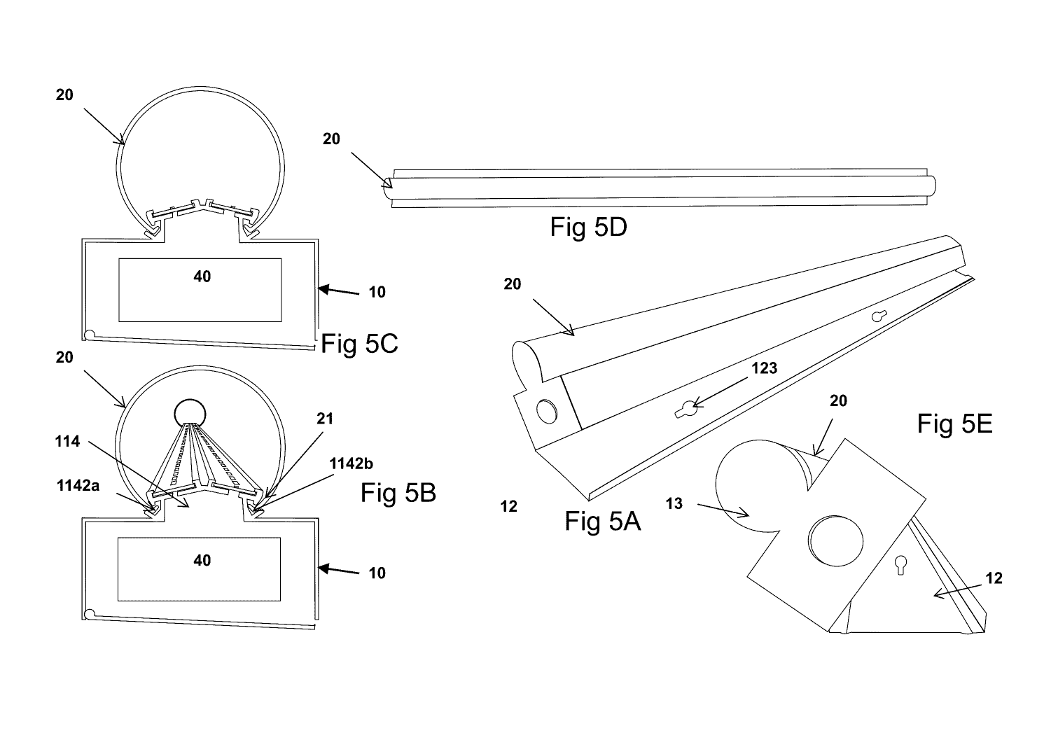

A complete lighting fixture which comprises a subassembly of the base 11, the back plate 12 and the two end covers 13, 14, a diffusion cover 20, two LED arrays 30 and a LED driver 40 is illustration in FIGS. 5A to 5E. As described above, the end covers take the shape of the cross section of the subassembly of the base 11 and the back plate 12 so that the contour of the lighting device is unitary and smooth.

One of he opening 131, 141 of the front end cover 13 or the rear end cover 14 can be fitted with a fan subassembly to improve dissipation from the casing. Alternatively or additionally, a fan subassembly 15 can be mounted on a one of side walls 112 and 113 of the base 11.

The diffusion cover 20 of the lighting device can be made from any conventional materials in the art, e.g. transparent glass, PVC and Acrylic, or opaque but translucent glass, PVC and Acrylic.

It is preferable that the diffusion cover is configured to a shape that facilitates light diffusion. In the embodiment shown in FIGS. 5B and 5C, the diffusion cover has a tubular body with a portion being cut away. The cut way portion forms two legs portions that are received in two grooves 1142a, 1142b formed on the seat portion 114 by sliding along the grooves. The tubular body is configured such that the LED arrays are enclosed in a chamber form by the base and the tubular body. The leg portions may have flanges to facilitate positioning of the diffusion cover relative to the base. In alternative embodiments, the grooves 1142, 1142b for receiving the leg portions can be provided, in one variant, on the web portion of the base so that the seat portion 114 is also enclosed within the chamber or, in other variants, on the junctions of the web portion and the sidewalls so that the entire web portion 111 is enclosed in the chamber formed.

In the embodiments shown in FIGS. 5B and 5C, the diffusion cover 20 can be slid into the slots provided on the seat portion from either end. In other embodiments, the slots can be blind slots or slots have blocking members to define the position of the diffusion cover 20 within the slots.

As mentioned above, the configuration of the diffusion cover 20 can be any shape corresponding to the arrangement of LED arrays and the slots for accommodating the LED arrays. Preferably however the diffusion cover 20 has a round hollow tubular body with an opening extends along the entire length of the body, as shown in FIGS. 5A and 5D, which intimates the traditional tubular fluorescent lighting fixture and can therefore easily acceptable to consumers. Other configurations such as, square tubes with an opening, rectangular tubes with an opening, diamond tube with an opening, oval tube with an opening and parallelogram tube with an opening, among other things, are all within the meaning the present invention without intend to limit.

In exemplary embodiments as shown in FIGS. 5A and 5E, the back plate 12 is provided with mounting holes for affixing the back plate and thus the entire LED lighting fixture onto the ceiling via fasteners such as screws. The back plate 12 is being configured detachable from the base 11 would be advantageous when fastening the LED fixture onto the ceiling is required since the detachable back plate can facilitate the fastening process, i.e. instead of holding the entire LED lighting fixture during the fastening process, a electrician can fasten the back plate 12 to the ceiling at first and then affix other members to the back plate sequentially. As a result, the LED lighting fixture can be affixed to the ceiling only by one electrician.

In another embodiment of the present invention, additionally or alternatively, the back plate 12 can be magnetically couple to a metal, preferably steel or cast iron, base member of a traditional lighting panel. In one example, the back plate can be partially magnetized or completely magnetized so that the back plate can be magnetically couple to the base member of the lighting panel directly. In another example, at least one pair of magnetic bar can be affixed to the back plate, preferably approximate the longitudinal or lateral ends of the back plate, so that the back plate can be magnetically coupled to the base member of the lighting panel via these magnetic bars. The back plate or the magnetic bar can be made from neodymium based magnetic material, and more preferably, it is made from magnetic materials having high temperature performance such as Nd—Fe—Be magnetic material.

As can be appreciated by those skilled in the art, the LED lighting fixture can also be fixedly connected o the base member of a traditional lighting panel 200 via the mounting holes 123 mentioned above.

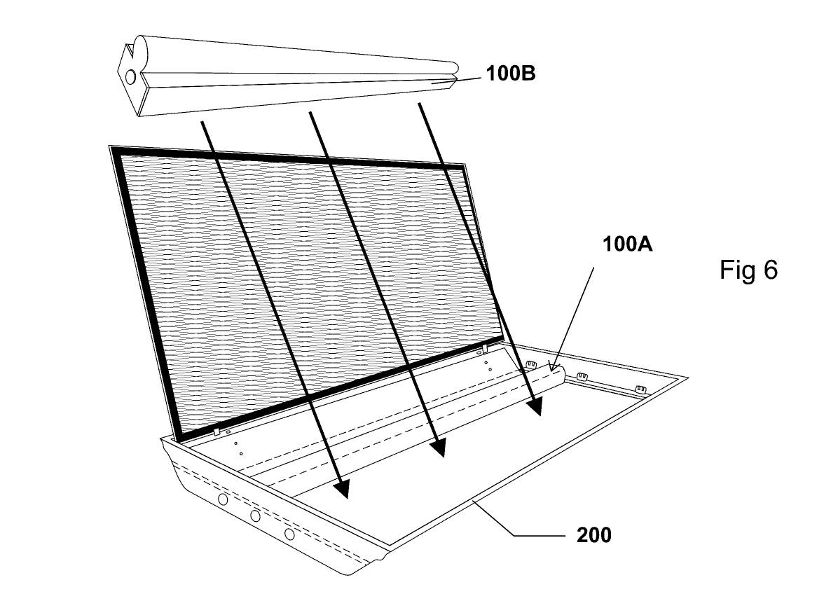

FIG. 6 shows a traditional lighting panel 200 with one LED lighting fixture 100A of the present invention affixed thereon and another LED lighting fixture 100B of the present invention in a “about to be affixed” state. From the illustration, the LED lighting fixtures can be feasibly retrofit to the base member of the lighting panel 200 as they have a substantially similar configuration as the traditional fluorescent tube fixture.

It can be seen that the LED lighting fixture in the present invention can replace traditional lighting devices such as fluorescent light tubes or LED tubes. More importantly, the heat dissipation efficient can be increased to approximately 100% when the casing in the present inventive is employed. Also, the base member of a traditional lighting panel can be used to assist heat dissipation which makes the design an all-in-one lighting fixture with supreme heat dissipation performance.

In addition to the traditional Fluorescent tube based lighting panel 200, the LED lighting fixture can also be retrofitted to a base member of any lamp fixtures which has a cover to replace the incandescent bulbs or CFL bulbs in the cover.

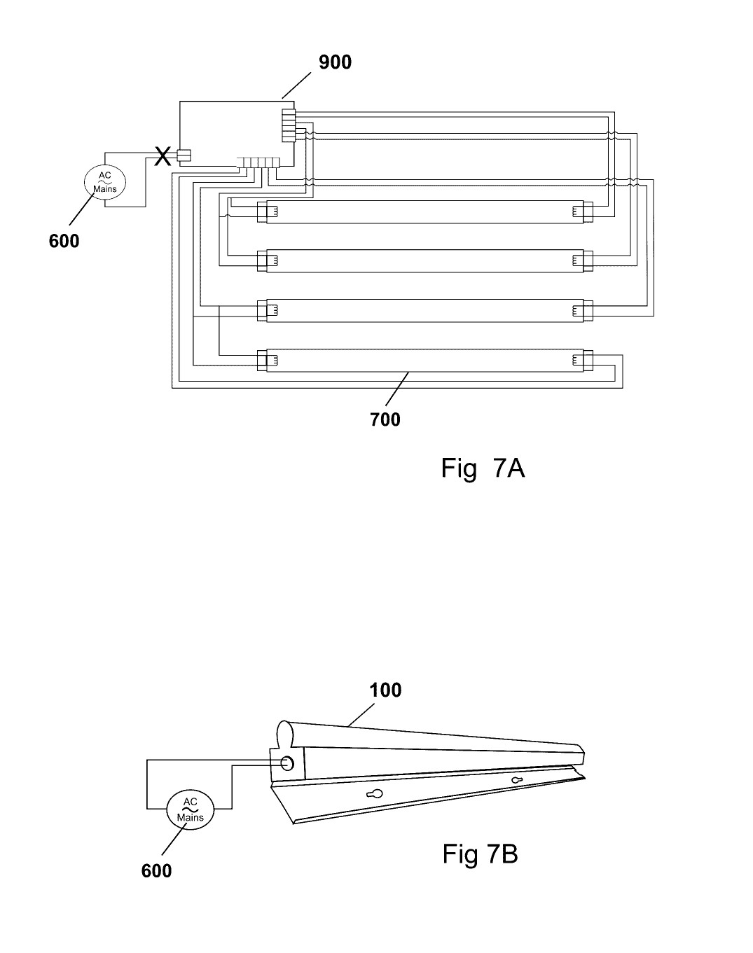

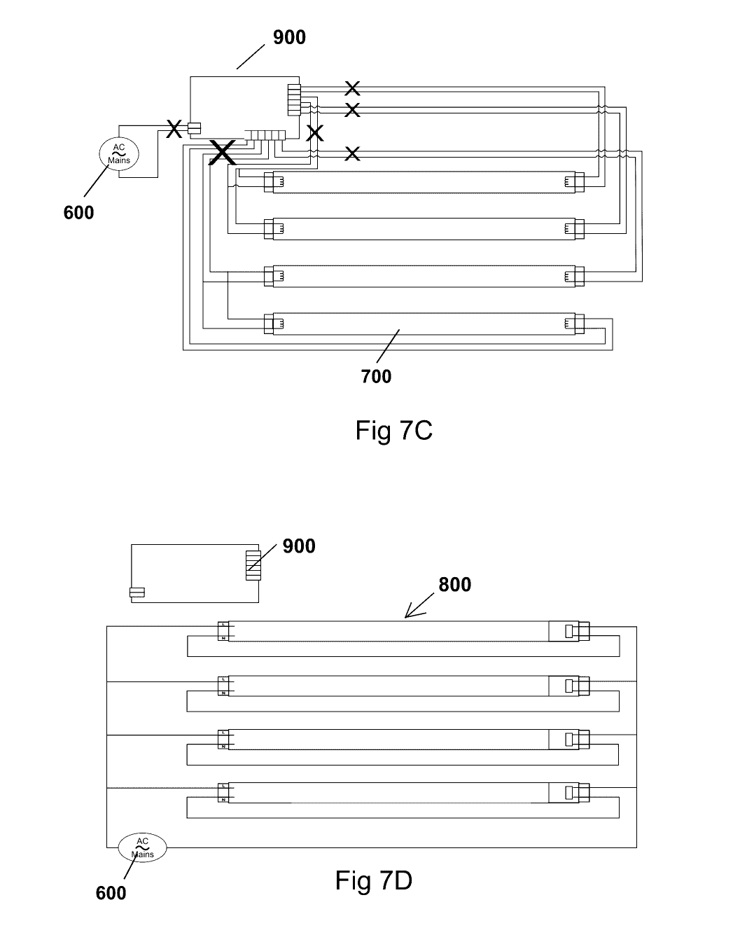

The fabricating process of retrofitting the present LED lighting fixture to the lighting panel 200 is also simplified when compared with the low power LED tube in the art. As shown in FIGS. 7C and 7D, in the prior art, several LED tubes 800 are required for reaching the total lumen due to the low output power of each LED tube. As a result, all connection wires extended from a ballast 900 of the lighting panel should be maintained for connecting the LED tubes 800 to the AC electric supply or power source 600, as shown in FIGS. 7C and 7D. LED lighting fixture in the present invention bears at least one LED array which can achieve high output power, as a result, retrofitting of the LED lighting fixture in the present invention to the traditional lighting panel requires only two simple steps, i.e. cutting off the power lines of the electric supply 600 to the ballast 900 and connecting the power lines to the L and N leads of the LED driver assembly 40, as shown in FIGS. 7A and 7B.

What is claimed is:

1. A heat sink casing comprising,
an elongated base having a seat portion for receiving at least one LED bar; and
a back plate coupled to the base and provided with an interface to a base member of a traditional lighting panel;
wherein both the base and the back plate are made from thermal conductive material.

2. The heat sink casing of claim 1, wherein the interface comprises a magnetic interface.

3. The heat sink casing of claim 1, wherein the interface comprising at least one mounting hole though which the back plate is fastened to the base of the traditional lighting panel or to a ceiling.

4. The heat sink casing of claim 1, wherein the seat portion is configured to be receivable of a plurality of LED bars arranged in a herringbone, a triangle, a rectangular column, a polygonal column, a semi-sphere, a cylinder, or a half-cylinder.

5. The heat sink casing of claim 1, wherein the seat portion comprises at least one slot for receiving the at least one LED bar.

6. The heat sink casing of claim 5, wherein the seat portion comprising two slots for receiving two LED bars, wherein the two slots incline from their sides adjoined to one another to their sides distance to one another.

7. The heat sink casing of claim 1, wherein the base further comprises
a web portion,
a first sidewall elevated from the web portion and pivotably coupled to a side of the back plate; and
a second sidewall elevated from the web portion and securable to an opposite side of the back plate.

8. A LED lighting fixture, comprising
a heat sink casing comprising an elongated base having a seat portion for receiving at least one LED bar; and a back plate coupled to the base and provided with an interface to a base member of a traditional lighting panel; wherein both the base and the back plate are made from a thermal conductive material;
at least one LED bar received in the seat portion;
at least one LED driver coupled to the LED bar; and
a diffusion cover, coupled to the heat sink casing for diffusing the light emitted by the LED bar.

9. The LED lighting fixture of claim 8, wherein the interface comprising a magnetic interface.

10. The LED lighting fixture of claim 8, wherein the interface comprises at least one mounting hole though which the back plate is fastened to the base of the traditional lighting panel or to a ceiling.

11. The LED lighting fixture of claim 8, wherein the seat portion is configured to be receivable of a plurality of LED bars arranged in a herringbone, a triangle, a rectangular column, a polygonal column, a semi-sphere, a cylinder, or a half-cylinder.

12. The LED lighting fixture of claim 8, wherein the seat portion comprises at least one slot for receiving the at least one LED bar.

13. The LED lighting fixture of claim 12, wherein the seat portion comprising two slots for receiving two LED bars, wherein the two slots incline from their sides adjoined to one another to their sides distance to one another.

14. The LED lighting fixture of claim 8, wherein the base further comprises
a web portion,
a first sidewall elevated from the web portion and pivotably coupled to a side of the back plate; and
a second sidewall elevated from the web portion and securable to an opposite side of the back plate.

15. The LED lighting fixture of claim 14, further comprising a front cover affixed to a front end of the base and a rear cover affixed to a rear end of the base so that a chamber is formed.

16. The LED lighting fixture of claim 15, the front cover and the rear cover are affixed on the base with screws which act as pin for pivotably coupling the back plate and the first sidewall.

17. The LED lighting fixture of claim 14, at least one of the front cover and the rear cover is provided with an opening for connecting wires of the LED driver to extend through.

18. The LED lighting fixture of claim 14, further comprising a fan assembly attached to an opening provided on at least one of the front cover and the rear cover, or on one of the first side wall or the second side wall.

19. The LED lighting fixture of claim 8, the LED bar comprising a printed circuit board by which it is received in the slot of the seat portion; and a plurality of LED components mounted on the printed circuit board; wherein the printed circuit board is coated with high thermal conductive material.
